(19) United States
(12) Patent Application Publication
(10) Pub. No.: US 2009/0064001 A1
(43) Pub. Date: Mar. 5, 2009

(54) Personalizing Default Settings on a GUI

(76) Inventor: Nicole Summers Robbins, Apex, NC (US)

Correspondence Address: LAW OFFICE OF JIM BOICE, 3839 BEE CAVE ROAD, SUITE 201, WEST LAKE HILLS, TX, 78746, US

(21) Appl. No.: 11/847,888

(22) Filed: Aug. 30, 2007

(51) Int. Cl. G06F 3/00

(52) U.S. Cl. 715/762

(57) ABSTRACT

A user is afforded the ability to set permanent default settings on a Graphical User Interface (GUI). When the user holds down a selector for a GUI setting for a predetermined period of time, or for a predetermined number of times, that selected GUI setting is set as the default setting for that user.

### BACKGROUND OF THE INVENTION

The present disclosure relates to the field of computers, and specifically to software. Still more specifically, the present disclosure relates to setting default settings on a Graphical User Interface (GUI).

In a typical GUI that allows user input, there are system defaults that have been pre-set by a system designer. The defaults displayed may be those believed by the system designer to be most commonly chosen (e.g., an “OK” button). Alternatively, the defaults may be for a desired void (e.g., an empty text field). Many times, these defaults do not fit those that an individual user needs.

### BRIEF SUMMARY OF THE INVENTION

The present invention allows a user to set permanent default settings on a Graphical User Interface (GUI). When a user holds down a selector for a GUI setting for a predetermined period of time, or for a predetermined number of times, that selected GUI setting is set as the default setting for that user.

The above as well as additional objectives, features, and advantages of the present invention will become apparent in the following detailed written description.

### BRIEF DESCRIPTION OF THE SEVERAL VIEWS OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 depicts an exemplary computer in which the present invention may be implemented;

FIG. 2 illustrates an exemplary Graphical User Interface (GUI) in which default settings may be set by a user;

FIG. 3 depicts an exemplary Integrated Development Environment (IDE) in which a default cursor focus can be set by the user; and

FIG. 4 is a flow-chart of exemplary steps taken to allow a user to set default settings for a GUI.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

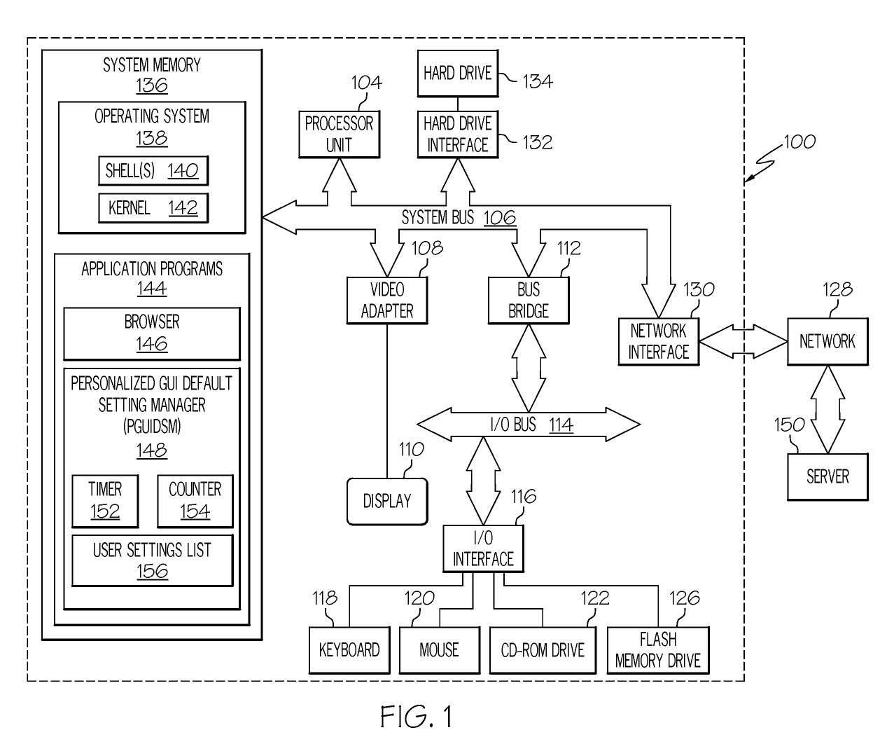

With reference now to FIG. 1, there is depicted a block diagram of an exemplary computer 100, with which the present invention may be utilized. Computer 100 includes a processor unit 104 that is coupled to a system bus 106. A video adapter 108, which drives/supports a display 110, is also coupled to system bus 106. System bus 106 is coupled via a bus bridge 112 to an Input/Output (I/O) bus 114. An I/O interface 116 is coupled to I/O bus 114. I/O interface 116 affords communication with various I/O devices, including a keyboard 118, a mouse 120, a Compact Disk—Read Only Memory (CD-ROM) drive 122, and a flash memory drive 126. The format of the ports connected to I/O interface 116 may be any known to those skilled in the art of computer architecture, including but not limited to Universal Serial Bus (USB) ports.

Computer 100 is able to communicate with a server 150 via a network 128 using a network interface 130, which is coupled to system bus 106. Network 128 may be an external network such as the Internet, or an internal network such as an Ethernet or a Virtual Private Network (VPN). Server 150 may be architecturally configured in the manner depicted for computer 100.

A hard drive interface 132 is also coupled to system bus 106. Hard drive interface 132 interfaces with a hard drive 134. In one embodiment, hard drive 134 populates a system memory 136, which is also coupled to system bus 106. System memory 136 is defined as a lowest level of volatile memory in computer 100. This volatile memory may include additional higher levels of volatile memory (not shown), including, but not limited to, cache memory, registers, and buffers. Code that populates system memory 136 includes an operating system (OS) 138 and application programs 144.

OS 138 includes a shell 140, for providing transparent user access to resources such as application programs 144. Generally, shell 140 (as it is called in UNIX®) is a program that provides an interpreter and an interface between the user and the operating system. Shell 140 provides a system prompt, interprets commands entered by keyboard 118, mouse 120, or other user input media, and sends the interpreted command(s) to the appropriate lower levels of the operating system (e.g., kernel 142) for processing. As depicted, OS 138 also includes kernel 142, which includes lower levels of functionality for OS 138. Kernel 142 provides essential services required by other parts of OS 138 and application programs 144. The services provided by kernel 142 include memory management, process and task management, disk management, and I/O device management.

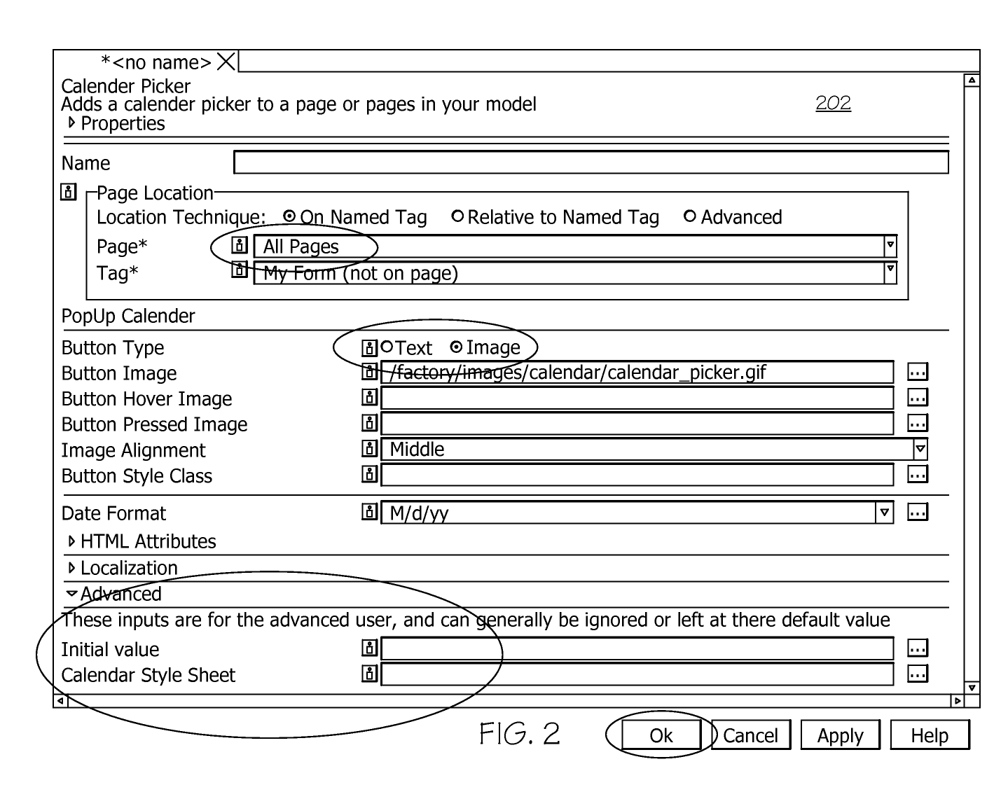

Application programs 144 include a browser 146. Browser 146 includes program modules and instructions enabling a World Wide Web (WWW) client (i.e., computer 100) to send and receive network messages to the Internet. Computer 100 may utilize HyperText Transfer Protocol (HTTP) messaging to enable communication with server 150. Application programs 144 in system memory 136 also include a Personalized Graphical User Interface Default Setting Manager (PGUIDSM) 148. PGUIDSM 148 performs the functions illustrated below in FIGS. 2-4. Note also that PGUIDSM 148 includes a timer 152 and a counter 154. Timer 152 includes software logic (which alternatively may be implemented in hardware—not shown) that measures how long a user continuously and uninterruptedly holds down a selection input (e.g., continuously holding down a left button on a mouse for more than three seconds) to select a GUI setting. Counter 154 measures (in software, or alternatively in hardware—not shown) how many times a user clicks a GUI setting, either within a pre determined amount of time (operating in conjunction with timer 152 to determine how many times a particular user has selected a specific GUI setting within a pre-defined amount of time), or for any unlimited past period of time (e.g., how many times a particular user has ever selected a specific GUI setting). Furthermore, associated with (or part of) PGUIIDSM 148 is a user settings list 156, which stores current and/or default GUI settings for particular users.

In one embodiment, computer 100 is able to download PGUIDSM 148 from service provider server 150, preferably in an “on demand” basis. Note further that, in a preferred embodiment of the present invention, service provider server 150 performs all of the functions associated with the present invention (including execution of PGUIDSM 148), thus freeing computer 100 from using its own resources.

The hardware elements depicted in computer 100 are not intended to be exhaustive, but rather are representative to highlight essential components required by the present invention. For instance, computer 100 may include alternate memory storage devices such as magnetic cassettes, Digital Versatile Disks (DVDs), Bernoulli cartridges, and the like. These and other variations are intended to be within the spirit and scope of the present invention. Note that the hardware architecture for service provider server 150 may be substantially similar to that shown for computer 100.

Referring now to FIG. 2, assume that an application developer is using a portlet factory (e.g., IBM's WebSphere™ Portlet Factory) to create portal applications for internal and external use in an enterprise. The application developer frequently makes choices and inputs into forms that generate reusable components for portlet apps. The application developer may work with numerous builder forms. Setting default settings for the different forms required inefficient and repetitive steps in the prior art. Specifically, the application developer had to click an option (often from another window) every time a particular form was used.

For example, assume that the application developer is working on adding a calendar date picker to the web application, as shown in Graphical User Interface (GUI) 202 in FIG. 2. The calendar picker may be used on many different applications. Thus, by setting the default settings for the calendar picker, every time the calendar picker is used for different applications, the default settings for the calendar picker remain the same.

In the example shown in GUI 202 in FIG. 2, the application developer has selected “AllPages” from the Page dropdown selection. Thus, when the application developer clicks on the field to see the options in the dropdown, “AllPages” appears, which the application developer clicks and holds for a predetermined period of time. For example, if the application developer holds the click for more than three seconds, then the computer “understands” that this setting (“AllPages”) is to be that user's default setting of placing the named tag “myForm” on all pages. The selection is set for this session and as the permanent default setting.

The application developer has also selected an image for the button that invokes the calendar picker. By clicking and holding the mouse button on the “Image” radio button for Button Type, this selection is likewise set for this session and all future sessions until the application developer sets a different default in the same manner.

In the example described in FIG. 2, the application developer interacts with the same portions of the form, and would prefer to have the “Advanced” section open. Thus, by clicking and holding the twisty graphic for the “Advanced” section the “Initial value” and “Calendar Style Sheet” options are made visible as default settings for this particular application developer for this and future sessions until the application developer sets a different default in the same manner.

In the example described, assume that the application developer always prefers to use the “OK” button rather than the “Apply” button. Thus, the application developer is able to make the “OK” button in focus (by holding the cursor over the “OK” button and then holding the left mouse button down continuously for a pre-determined period of time) as a default setting. Thus, when the application developer is finished with a current session with the form of GUI 202, the next time he works with a Calendar Picker builder form, the “OK” button will be in focus. That is, when the user hits the “Enter” button on his keyboard, the “OK” button, rather than the “Apply” button, will be activated. Note that this is due to the user making the “OK” button the default condition for cursor focus. Alternatively, the “Apply” button or any other button shown in GUI 202 may be deemed and appointed the default focus to be associated with hitting the “Enter” key on the keyboard.

The next time the application developer works with a Calendar Picker builder shown in GUI 202, he sees the defaults he prefers.

Assume now that the application developer is developing his fourth Portal application when he notices that he usually types in the same value in the “Initial value” text field. This time, he begins typing “Lorem ipsum”. After typing the “L”, he's presented with two values he's input before, so he clicks and holds on “Lorem ipsum”. The value is now selected for this and future interactions with the form.

Assume also that the application developer likes to name his builders last, but that he seems to always forget to double check which style sheet the calendar picker will use. To help him remember to check, he wants to move the default cursor focus from the Name field to the Calendar Style Sheet field. To do so, he clicks and holds inside the input box which places the cursor in the field for now and sets it as the default focus until he changes the default again.

Eventually, the application developer will find that a default he has set is no longer what he needs. So he simply changes that one default and his others are still in place. It is easier for the application developer to use this method of saving defaults so he doesn't have to remember which of a set of saved templates best meets his current needs (easier than saved defaults). He also prefers this method over the system remembering his latest entries because he knows that occasionally, he'll need to select a different value. For example, this time, he selects “Text” as the button type, but wants to preserve his default selection of “Image” as default. He couldn't preserve that if the system just remembered the latest selection.

Note that in one embodiment, a visual cue is provided to confirm a selection or input has been set as the default. An exemplary visual cue may be a simple blinking action on the GUI element being set.

Note also that the exact amount of time to hold the click may be determined after user testing. That is, each application developer may alter the length of time that he needs to hold the mouse button in order to set the setting permanently. This time length may be determined by experimentally testing a particular user. Thus, if one user (during customization testing) repeatedly lets the mouse button up after only two seconds, then two second will be the amount of time that the system recognizes as being necessary to permanently set the setting as a default. If another user repeatedly holds down the mouse button for five seconds, then that is the amount of time used by the computer to determine that the setting is to be set as a permanent default for that user. Note also that the process described herein can be utilized to set defaults in Web-based or rich client interfaces, including dialogs, wizards, forms, property views, configurations, etc.

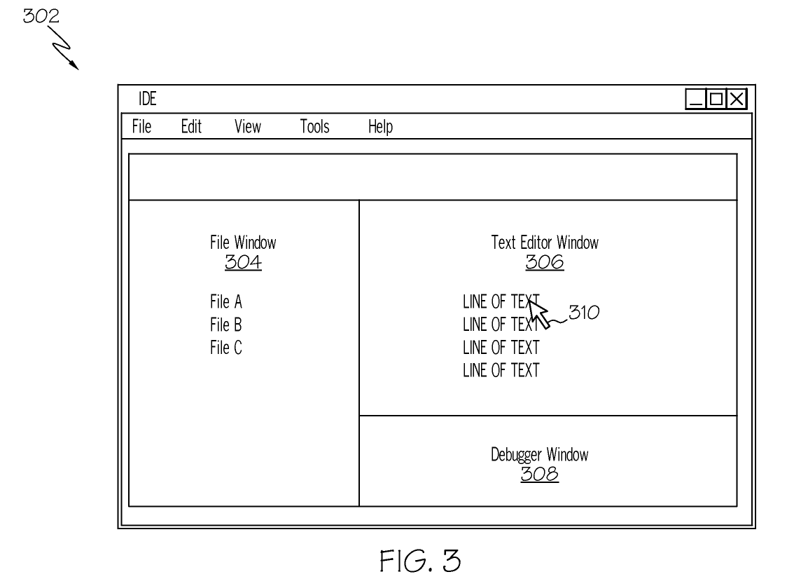

Referring now to FIG. 3, a GUI 302 for an Integrated Development Environment (IDE) is presented. Note that the IDE includes a file window 304, a text editor window 306, and a debugger window 308. The IDE may have the default cursor focus (for cursor 310) set for the file window 304. However, the user may prefer that the cursor focus be in the text editor window 306, perhaps even auto-set to be at the first line of text, or auto-set to a line of text that has been identified in the debugger window 308 as having an error. By holding the mouse button down for a predetermined period of time over the first (or erroneous) line of text, then the cursor focus will automatically be set as a default whenever this IDE is used in the future. In a similar example, assume that GUI 302 is actually for a webpage, and that the default cursor focus is on the Uniform Resource Locator (URL) pane of the webpage. However, the user may want the default to NOT be on the URL pane (e.g., for fear of overwriting the URL location), and prefers the default cursor focus be on a non-URL pane location. By holding down the mouse button for the prescribed amount of time (or, alternatively number of clicks), then whenever that webpage (or alternatively, another webpage) is displayed, the cursor focus will be on a non-URL pane location on the webpage.

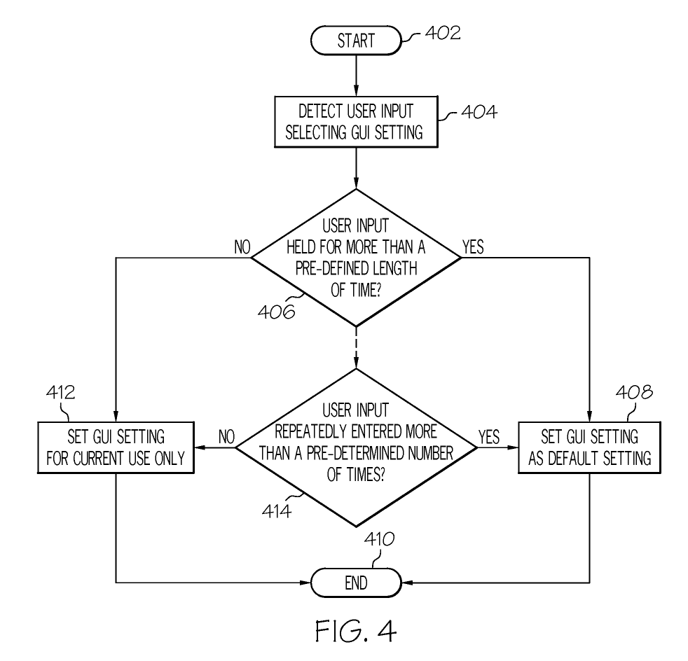

Referring now to FIG. 4, a flow-chart of exemplary steps taken to allow a user to permanently set GUI default settings is presented. After initiator block 402, a computer program (e.g., PGUIDSM 148 shown in FIG. 1) detects that a user has selected a particular GUI setting (such as those shown and described above in FIG. 2 and FIG. 3). As described in query block 406, if the user holds down the mouse button longer than some predetermined period of time (e.g., more than three seconds), then that particular GUI setting is permanently set as a default setting for that user (block 408), and the process ends (block 410). However, if the mouse button is quickly released, then that particular GUI setting is only for the current session (block 412), and is NOT set as a permanent default setting.

In an alternate embodiment, a query can be made as to whether the setting selection has been made a pre-determined number of times (query block 414). These setting selections may occur within some pre-determined period of time or usages. That is, a counter (e.g., counter 154 shown in FIG. 1) may count the user selecting a particular GUI setting over the course of a single session at a GUI, or during some pre-defined length of time (e.g., during the course of five minutes), or for all time (keeping track of every time a user selects a particular GUI setting during all sessions). If the count is high enough, then the repeatedly selected GUI setting will then be set as the default setting (block 412).

Note that in one embodiment, the term “permanent default setting” is defined as meaning that a setting is permanent until the user changes it. In another embodiment, the term “permanent default setting” is defined as meaning that the setting is permanent until an administrator changes it. In yet another embodiment, the term “permanent default setting” is defined as meaning that the setting is truly permanent, and cannot be changed by anyone.

As described herein, the present invention enables end users to save defaults at a very granular level, without straying from their task flow. By pressing and holding, for “x” amount of time, the left mouse button (or any other similar user-defined or architect-defined selection device that can be controlled by an end user) on the value or selection or state of a widget, the user sets as a default the value/selection/state selected. This sets the value or selection or state for the current session and is saved as that user's default for future sessions. With this solution, users are able to set defaults for the many GUI elements without leaving their current screen and without having to manage saved selections. Such GUI elements include, but are not limited to, radio buttons, check boxes, dialog buttons, dropdown selections, twisties (images used to denote a row in a view or a section in a document that is expandable—e.g., collapsible sections), text fields (via type-ahead feature or cookies), cursor focus. Advantages over the prior art include, but are not limited to: 1) no management of saved instances or template; 2) user's task flow isn't interrupted; 3) utilizes current technology; 4) granularity allows maximum user control over default preferences; 5) gives user control over defaults on GUI parts that, in the prior art, are not changeable by the user (dialog buttons (OK, Cancel, etc) and collapsible sections (twisties).

Note that the flowchart and block diagrams in the figures illustrate the architecture, functionality, and operation of possible implementations of systems, methods and computer program products according to various embodiments of the present invention. In this regard, each block in the flowchart or block diagrams represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A computer-implementable method for personalizing default setting in a Graphical User Interface (GUI), the computer-implementable method comprising:
detecting, from a user, a user input that selects a GUI setting for a GUI function;
determining that the user input has been sustained uninterrupted for more than a pre-defined period of time; and
in response to determining that the user input has been sustained uninterrupted for more than the pre-defined period of time, setting the GUI setting as a permanent default setting for the user.

2. The computer-implementable method of claim 1, wherein the user input is performed by the user selecting the GUI setting without leaving a current screen.

3. The computer-implementable method of claim 2, wherein the user input results from the user engaging a user input device while a cursor is positioned over a GUI function setting on the current screen.

4. The computer-implementable method of claim 3, wherein the user input device is a left click on a mouse.

5. The computer-implementable method of claim 1, further comprising:
determining that the user input has been input more than a pre-determined number of times within the pre-defined period of time; and
in response to determining that the user input has been input more than a pre-determined number of times within the pre-defined period of time, setting the GUI setting as the permanent default setting for the user.

6. The computer-implementable method of claim 1, wherein the GUI is for a first application that is utilized by multiple second applications, the permanent default setting for the first application is applied to all of the multiple second applications.

7. The computer-implementable method of claim 1, wherein the user input is from a check box displayed on the GUI.

8. The computer-implementable method of claim 1, wherein the user input is from a dropdown selection displayed on the GUI.

9. The computer-implementable method of claim 1, wherein the user input is from a user clicking a twisty, wherein clicking the twisty denotes a level of expansion setting of section in a document that is displayed on the GUI.

10. The computer-implementable method of claim 1, wherein the user input is a cursor focus on the GUI.

11. The computer-implementable method of claim 10, wherein the GUI is for an Integrated Development Environment (IDE), and wherein the permanent default setting for the user places the cursor focus in a text editor window in the IDE.

12. The computer-implementable method of claim 10, wherein the GUI is for a webpage, and wherein the permanent default setting for the user places the cursor focus in a non-Uniform Resource Locator (URL) window on the webpage.

13. A system comprising:
a processor;
a data bus coupled to the processor;
a memory coupled to the data bus; and
a computer-usable medium embodying computer program code, the computer program code comprising instructions executable by the processor and configured for personalizing default settings in a Graphical User Interface (GUI) by performing the steps of:
detecting, from a user, a user input that selects a GUI setting for a GUI function;
determining that the user input has been sustained uninterrupted for more than a pre-defined period of time; and
in response to determining that the user input has been sustained uninterrupted for more than the pre-defined period of time, setting the GUI setting as a permanent default setting for the user.

14. The system of claim 13, wherein the user input is performed by the user selecting the GUI setting without leaving a current screen.

15. The system of claim 13, wherein the instructions are further configured for:
determining that the user input has been input more than a pre-determined number of times within the pre-defined period of time; and
in response to determining that the user input has been input more than a pre-determined number of times within the pre-defined period of time, setting the GUI setting as the permanent default setting for the user.

16. The system of claim 13, wherein the user input is a cursor focus on the GUI, and wherein the GUI is for an Integrated Development Environment (IDE), and wherein the permanent default setting for the user places the cursor focus in a text editor window in the IDE.

17. A computer-readable medium encoded with a computer program, the computer program comprising computer executable instructions configured for:
detecting, from a user, a user input that selects a GUI setting for a GUI function;
determining that the user input has been sustained uninterrupted for more than a pre-defined period of time; and
in response to determining that the user input has been sustained uninterrupted for more than the pre-defined period of time, setting the GUI setting as a permanent default setting for the user.

18. The computer-implementable method of claim 17, wherein the user input is performed by the user selecting the GUI setting without leaving a current screen.

19. The computer-readable medium of claim 17, wherein the computer-usable medium is a component of a remote server, and wherein the computer executable instructions are deployable to a local computer from the remote server.

20. The computer-readable medium of claim 17, wherein the computer executable instructions are capable of being provided by a service provider to a customer on an on-demand basis.
